(19) United States
(12) Patent Application Publication
(10) Pub. No.: US 2006/0175908 A1
(43) Pub. Date: Aug. 10, 2006

(54) Mover for linear oscillatory actuator

(76) Inventors: Ju Lee, Seoul (KR); Tae-Heoung Kim, Gyunggi-do (KR); Sol Kim, Seoul (KR); Ki-Bong Jang, Seoul (KR); Jae-Hak Choi, Seoul (KR); Ion Boldea, Timisoara (KR)

Correspondence Address: SUGHRUE MION, PLLC, 2100 PENNSYLVANIA AVENUE, N.W., SUITE 800, WASHINGTON, DC, 20037, US

(21) Appl. No.: 10/564,628

(22) PCT Filed: Nov. 21, 2003
(86) PCT No.: PCT/KR03/02529

§ 371 Date: Jan. 13, 2006

(30) Foreign Application Priority Data
Jul. 16, 2003 (KR) 10-2003-0048834

(51) Int. Cl. H02K 41/00

(52) U.S. Cl. 310/12

(57) ABSTRACT

The present invention relates to a mover for a linear oscillatory actuator to be linearly reciprocated, which is easy to assemble and manufacture and has improved durability. In a mover according to the present invention, permanent magnets and cores which have corresponding shapes are alternately arranged with each other, and this arranged state is fixed by virtue of fastening means. In another mover according to the present invention, plate-shaped cores are stacked one upon another, permanent magnets are inserted into insertion holes defined in the plate-shaped cores, and this inserted state is fixed by virtue of fastening means.

### TECHNICAL FIELD

The present invention relates to a mover for use in a linear oscillatory actuator which is adapted to be linearly reciprocated, is easy to assemble and manufacture, and has improved durability.

In a mover according to the present invention, permanent magnets and cores which have corresponding shapes are alternately arranged with each other, and this arranged state is fixed by virtue of fastening means.

In another mover according to the present invention, plate-shaped cores are stacked one upon another, permanent magnets are inserted into insertion holes defined in the plate-shaped cores, and this inserted state is fixed by virtue of fastening means.

### BACKGROUND ART

As is well known in the art, a linear motor has a shape which is obtained by axially cutting and deploying a general rotary motor. Therefore, the rotary motor generates a rotation force, whereas the linear motor generates a thrust force.

As a kind of such a linear motor, a linear oscillatory actuator refers to a driving device wherein sine or rectangular pulse voltage waves are alternately supplied to repeatedly apply an optional linear stroke to a mover to thereby cause the mover to be linearly reciprocated. Linear oscillatory actuators are divided into a coil driving type, a core driving type, and a permanent magnet driving type.

In the permanent magnet driving type linear oscillatory actuator, as a direct current is applied to coils of a stator, the stator is magnetized to serve as an electromagnet, by which a mover comprising a permanent magnet is linearly moved under the action of an attractive force and a repulsive force. Then, as a direction of the current applied to the coils of the stator is changed, directions of the attractive force and repulsive force acting on the mover are changed, by which the mover is linearly moved in an opposite direction. Therefore, by continuously and alternately changing a direction of an exciting current in this way, the mover is linearly reciprocated.

In the conventional linear oscillatory actuator operated as described above, a mover has a cylindrical configuration in which a permanent magnet is arranged around a core and coupled to the core by adhesive or bolts.

Such conventional mover suffers from defects in that, since it is linearly reciprocated at a high speed, the permanent magnet of the mover is likely to be released or damaged.

Also, in the conventional mover for the linear oscillatory actuator, because the permanent magnet is fastened to the core by means of bolts and nuts, productivity is deteriorated in manufacture.

Further, in the conventional art, in order to enhance durability of the mover, the mover is composed of the permanent magnet and the core. In this regard, due to the fact that the permanent magnet is arranged around and coupled to the core, a mass of the mover increases, and a great inertia force is produced in the linearly reciprocating mover. As a result, since limitations necessarily exist in increasing a speed of linear reciprocating movement of the mover, a reciprocating frequency cannot but be restricted to several Hz.

### DISCLOSURE OF INVENTION

Accordingly, the present invention has been made in an effort to solve the problems occurring in the related art, and an object of the present invention is to provide a mover for a linear oscillatory actuator, which renders improved durability, productivity and operational reliability.

In order to achiever the above object, according to one aspect of the present invention, there is provided a mover for a linear oscillatory actuator, comprising: a plurality of permanent magnets each having the shape of a plate; a plurality of cores each insulated on its surface and having the shape of a plate to correspond to the shape of the permanent magnet; fastening means for fixing an arranged state of the permanent magnets and the cores which are alternately arranged with each other; and returning means acting in the same direction as a linear movement direction of the mover.

According to another aspect of the present invention, there is provided a mover for a linear oscillatory actuator, comprising: a plurality of plate-shaped permanent magnets; a plurality of plate-shaped cores each insulated on its surface and defined with a plurality of insertion holes through which the permanent magnets are inserted, the plate-shaped cores being stacked one upon another in a direction orthogonal to a linear movement axis of the mover; fastening means for fixing a state in which the permanent magnets are inserted into the insertion holes defined in the cores; and returning means acting in the same direction as a linear movement direction of the mover.

### BRIEF DESCRIPTION OF DRAWINGS

The above and other objects, features and other advantages of the present invention will be more clearly understood from the following detailed description when taken in conjunction with the accompanying drawings, in which:

FIG. 1 is a schematic exploded perspective view illustrating a linear oscillatory actuator in which a mover according to the present invention is used;

FIG. 2 is an exploded perspective view illustrating a mover in accordance with an embodiment of the present invention;

FIG. 3 is a perspective view illustrating an assembled state of the mover shown in FIG. 2;

FIG. 4 is an exploded perspective view illustrating a mover in accordance with another embodiment of the present invention;

FIG. 5 is a perspective view illustrating an assembled state of the mover shown in FIG. 4; and

FIG. 6 is an exploded perspective view illustrating alternative fastening means in the mover shown in FIG. 4.

### BEST MODE FOR CARRYING OUT THE INVENTION

Reference will now be made in greater detail to a preferred embodiment of the invention, an example of which is illustrated in the accompanying drawings. Wherever possible, the same reference numerals will be used throughout the drawings and the description to refer to the same or like parts.

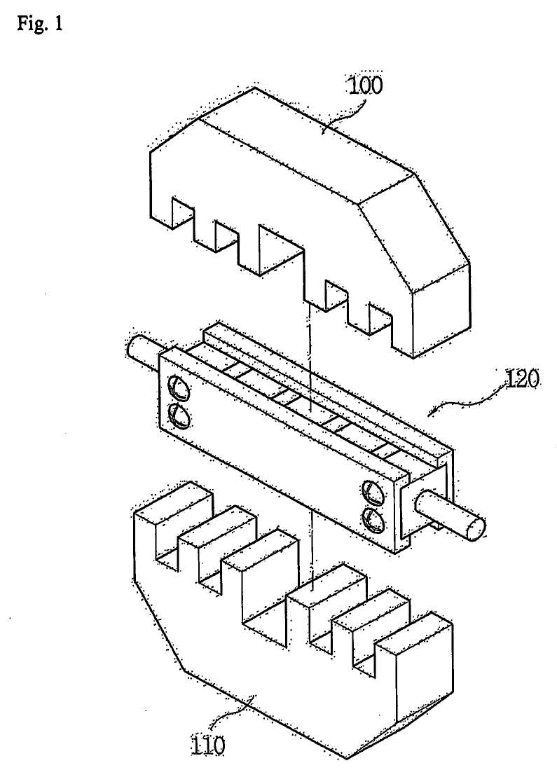

FIG. 1 is a schematic exploded perspective view illustrating a linear oscillatory actuator in which a mover according to the present invention is used. The mover designated by the reference numeral 120 is positioned between a pair of stators 100 and 110 in the linear oscillatory actuator and is linearly reciprocated to generate a linear driving force.

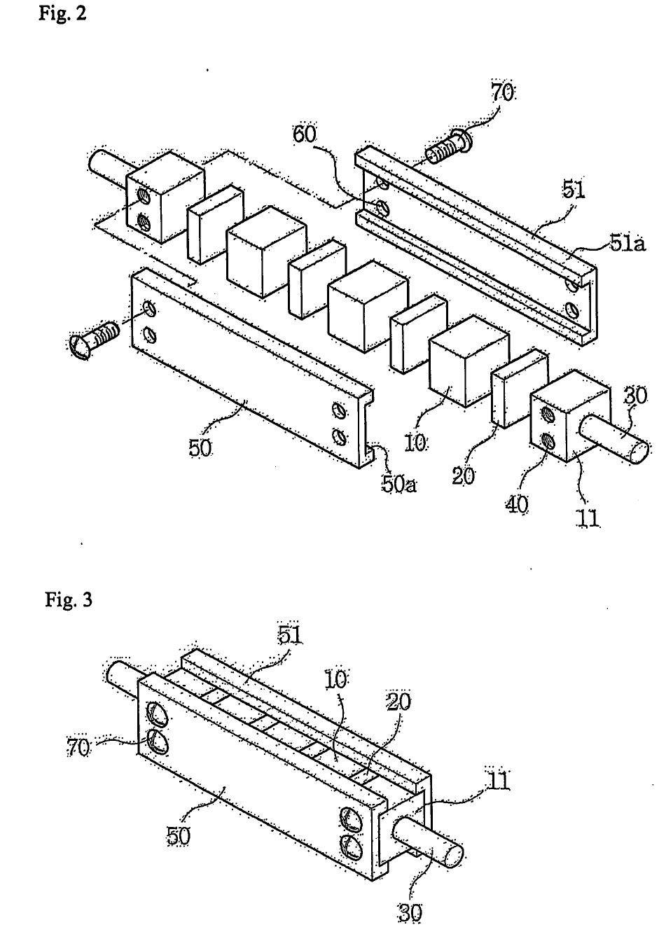

FIG. 2 is an exploded perspective view illustrating a mover in accordance with an embodiment of the present invention, and FIG. 3 is a perspective view illustrating an assembled state of the mover shown in FIG. 2. The mover 120 includes a plurality of permanent magnets 20 each having the shape of a plate, a plurality of cores 10 defining a path through which magnetic flux passes and covered with an insulating material, fastening means for fixing an arranged state of the permanent magnets 20 and cores 10 which are alternately arranged with each other, and returning means.

It is preferred that the permanent magnets 20 and cores 10 have the shape of a hexahedral plate to simplify a shape of a stator and a winding pattern of coils which are wound on the stator. It is preferred that the permanent magnets 20 and the cores 10 are bonded to each other by adhesive to contribute to improving durability of the mover.

The fastening means shown in FIGS. 2 and 3 comprises a pair of fastening plates 50 and 51 for fixing an arranged state of the permanent magnets 20 and cores 10 which are alternately arranged with each other. It is preferred that the fastening means is made of a non-magnetic material.

The fastening plates 50 and 51 have bent projections 50a and 51a formed at both ends thereof when viewed in a direction orthogonal to a linear movement axis of the mover to securely fasten the permanent magnets 20 and the cores 10 to each other. In other words, the fastening plates 50 and 51 have a ‘[’-shaped longitudinal cross-section to surround the permanent magnets 20 and cores 10.

The fastening plates 50 and 51 are coupled and fastened to the permanent magnets 20 or the cores 10 by virtue of coupling means. Particularly, in the illustrated embodiment, in a state wherein the permanent magnets 20 and the cores 10 are alternately arranged with each other, two cores specifically designated by reference numeral 11 are respectively positioned at both ends of the mover 120 when viewed in the linear movement direction of the mover 120, and the pair of fastening plates 50 and 51 are coupled to the two cores 11 positioned at both ends of the mover 120 by virtue of the coupling means. In the illustrated embodiment, the coupling means comprises bolts 70, holes defined in the fastening plates 50 and 51, and threaded holes 40 defined in the two cores 11.

While it is the norm that the returning means employs a mechanical spring for making an electrical frequency and a mechanical frequency identical to each other, in the present embodiment, the returning means comprises shafts 30 which are positioned on the linear movement axis of the mover 120 to serve as support shafts for supporting linear reciprocating movement of the mover 120, and coil springs (not shown) which are fitted around the shafts 30. The shafts 30 are coupled to the two cores 11 positioned at both ends of the mover 120 to render an integrated structure of the cores 11 and the shafts 30.

When assembling the mover for a linear oscillatory actuator as shown in FIGS. 2 and 3, according to one embodiment of the present invention, the cores 10 and the permanent magnets 20 are positioned alternately with each other and then bonded to each other by adhesive. Also, at both ends of the mover 120, the cores 11 which are integrated with the shafts 30 are respectively bonded to the permanent magnets 20 by adhesive. Then, the permanent magnets 20 and the cores 10 which are alternately arranged with and bonded to each other are surrounded by the fastening plates 50 and 51, and the fastening plates 50 and 51 are fastened to the two shaft-integrated cores 11, respectively, using the bolts 70.

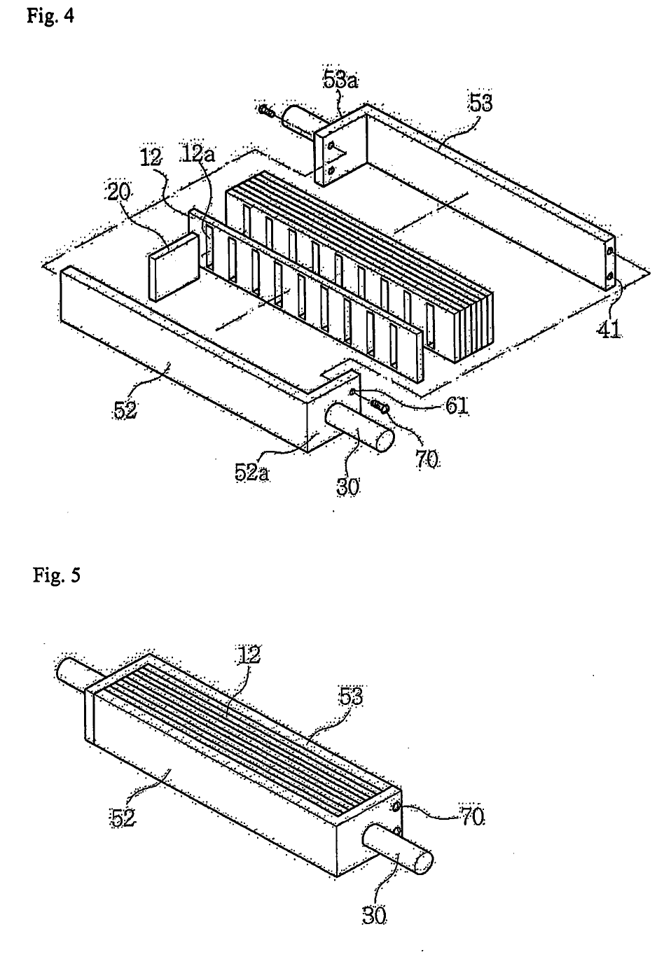

Next, another embodiment of the present invention will be described in detail with reference to FIGS. 4 through 6.

First, referring to FIGS. 4 and 5, a mover according to another embodiment of the present invention includes a plurality of plate-shaped permanent magnets 20, a plurality of plate-shaped cores 12 each covered with an insulating material and defined with a plurality of insertion holes 12a through which the permanent magnets 20 are inserted, the plate-shaped cores 20 being stacked one upon another, fastening means for fixing a state in which the permanent magnets 20 are inserted into the insertion holes 12a of the cores 12 stacked one upon another, and returning means.

It is preferred that the permanent magnets 20 have the shape of a hexahedral plate to simplify a shape of a stator and a winding pattern of coils which are wound on the stator. In this case, the insertion holes 12a defined in the core 12 have a cross-section corresponding to the permanent magnet 20.

As well known in the art, the reason why the plurality of plate-shaped cores 12 are stacked one upon another is to prevent deterioration of performance due to an eddy current which may be generated when only one core having the same thickness as the entire cores stacked one upon another is used. While it is advantageous that the core 12 comprises a thin plate to reduce an eddy current loss, in consideration of simplicity of a manufacturing procedure, it is preferred that the core 12 has a thickness of about 0.5 mm.

While the fastening plates 50 and 51 as shown in FIG. 2 can be used as the fastening means, it is preferred that fastening plates 52 and 53 as shown in FIG. 4 is used as the fastening means so as to securely fasten the stacked cores 12 to one another. Also, it is preferred that the fastening means is made of a non-magnetic material.

The fastening plates 52 and 53 function to fix the state in which the permanent magnets 20 are inserted into the insertion holes 12a defined in the cores 12 stacked one upon another. The fastening plates 52 and 53 have bent portions 52a and 53a to be brought into contact with both end surfaces of the stacked cores 12. Both end surfaces of the stacked cores 12 face a linear movement direction of the mover. That is to say, each of the fastening plates 52 and 53 has an ‘L’-shaped transverse cross-section, whereby the fastening means 52 and 53 can fully surround four faces of the stacked cores 12.

The fastening plates 52 and 53 are coupled to each other by virtue of coupling means. In the illustrated embodiment, the coupling means comprises bolts 70, coupling holes 61 defined in the bent portions 52a and 53a, and threaded holes 41 defined in the ends of the fastening plates 52 and 53 which are opposite to the bent portions 52a and 53a.

The returning means comprises shafts 30 which are positioned on a linear movement axis of the mover to serve as support shafts for supporting linear reciprocating movement of the mover, and coil springs (not shown) which are fitted around the shafts 30. In the drawings, the shafts 30 are coupled to the bent portions 52a and 53a of the fastening plates 52 and 53.

Hereinbelow, an assembling method of the mover according to another embodiment of the present invention will be described with reference to FIGS. 4 and 5.

After a necessary number of cores 12 are stacked one upon another, the permanent magnets 20 are respectively inserted into the insertion holes 12a defined in the cores 12. Then, the cores 12 having inserted therein the permanent magnets 20 are fastened to one another by virtue of the fastening means and the coupling means.

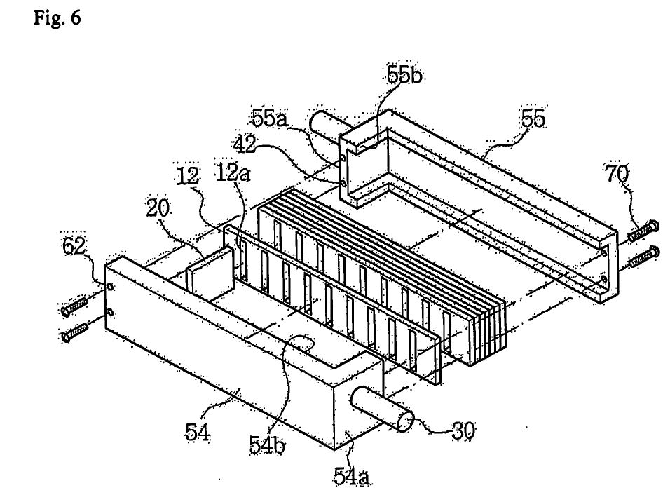

FIG. 6 is an exploded perspective view illustrating alternative fastening means in the mover shown in FIG. 4. When compared to the fastening plates 52 and 53 as shown in FIG. 4, fastening plates 54 and 55 as shown in FIG. 6 have bent projections 54b and 55b formed at both ends thereof when viewed in a direction orthogonal to the linear movement axis of the mover, to securely fasten the cores 12 stacked one upon another. In other words, the fastening plates 54 and 55 have a ‘[’-shaped longitudinal cross-section.

In a state in which the stacked cores 12 are surrounded by the fastening plates 54 and 55, the fastening plates 54 and 55 are fastened to each other by virtue of coupling means which comprises bolts 70, coupling holes 62 defined in the bent projections 54b and 55b, and threaded holes 41 defined in the ends of the fastening plates 54 and 55 which are opposite to the bent projections 54b and 55b.

### INDUSTRIAL APPLICABILITY

As apparent from the above descriptions, the mover for a linear oscillatory actuator according to the present invention provides advantages in that permanent magnets and cores are alternately arranged with each other and this arranged state is fixed by virtue of fastening means, or in that plate-shaped cores are stacked one upon another, permanent magnets are inserted into insertion holes defined in the plate-shaped cores, and this inserted state is fixed by virtue of fastening means. Consequently, operational efficiency of the mover is improved due to effective condensation of magnetic flux, the mover can be easily assembled, and it is possible to prevent the permanent magnets from being released from the mover whereby durability of the mover is improved.

Moreover, differently from the conventional mover for a linear oscillatory actuator which has a cylindrical configuration, in the mover according to the present invention, because a manufacturing procedure can be simplified and a manufacturing cost can be reduced, productivity can be improved.

Although a preferred embodiment of the present invention has been described for illustrative purposes, those skilled in the art will appreciate that various modifications, additions and substitutions are possible, without departing from the scope and spirit of the invention as disclosed in the accompanying claims.

1. A mover for a linear oscillatory actuator, comprising:
a plurality of permanent magnets each having the shape of a plate;
a plurality of cores each insulated on its surface and having the shape of a plate to correspond to the shape of the permanent magnet;
fastening means for fixing an arranged state of the permanent magnets and the cores which are alternately arranged with each other while being in contact with each other; and
returning means acting in the same direction as a linear movement direction of the mover.

2. The mover as set forth in claim 1, wherein each of the permanent magnet and the core has the shape of a hexahedral plate.

3. The mover as set forth in claim 1, wherein the permanent magnets and the cores are bonded to each other by adhesive.

4. The mover as set forth in any one of the claims 1 to 3, wherein the fastening means comprises a pair of fastening plates for surrounding the permanent magnets and cores alternately arranged with each other, each of the fastening plates having bent projections formed at both ends thereof when viewed in a direction orthogonal to a linear movement axis of the mover, the fastening plates being coupled to the permanent magnets or the cores by virtue of coupling means.

5. The mover as set forth in claim 4, wherein, in a state in which the permanent magnets and cores are alternately arranged with each other, cores are respectively positioned at both ends of the mover when viewed in the linear movement direction of the mover, and the pair of fastening plates are coupled to the cores positioned at both ends of the mover by virtue of the coupling means.

6. The mover as set forth in claim 5, wherein the returning means comprises shafts which are coupled to the cores positioned at both ends of the mover on the linear movement axis of the mover, and coil springs fitted around the shafts.

7. A mover for a linear oscillatory actuator, comprising:
a plurality of plate-shaped permanent magnets;
a plurality of plate-shaped cores each insulated on its surface and defined with a plurality of insertion holes through which the permanent magnets are inserted, the plate-shaped cores being stacked one upon another in a direction orthogonal to a linear movement axis of the mover;
fastening means for fixing a state in which the permanent magnets are inserted into the insertion holes defined in the cores; and
returning means acting in the same direction as a linear movement direction of the mover.

8. The mover as set forth in claim 7, wherein each permanent magnet has the shape of a hexahedral plate, and each insertion hole defined in the core has a cross-sectional shape which corresponds to the shape of the permanent magnet.

9. The mover as set forth in claim 6, wherein the fastening means comprises a pair of fastening plates which extend in the linear movement direction of the mover and have bent portions to be brought into contact with both end surfaces of the stacked cores, the fastening plates being coupled to each other by virtue of coupling means.

10. The mover as set forth in claim 9, wherein the fastening means has bent projections formed at both ends thereof when viewed in a direction orthogonal to the linear movement axis of the mover.

11. The mover as set forth in claim 9, wherein the returning means comprises shafts which are coupled to the bent portions of the fastening means on the linear movement axis of the mover, and coil springs fitted around the shafts.

12. The mover as set forth in claim 7, wherein the fastening means comprises a pair of fastening plates which extend in the linear movement direction of the mover and have bent portions to be brought into contact with both end surfaces of the stacked cores, the fastening plates being coupled to each other by virtue of coupling means.
